(19) United States
(12) Patent Application Publication
(10) Pub. No.: US 2021/0379809 A1
(43) Pub. Date: Dec. 9, 2021

(54) METHOD AND SYSTEM FOR MONITORING STATES OF INJECTION MOLDING MACHINE

(71) Applicant: HONGFUJIN PRECISION ELECTRONICS(TIANJIN)CO.,LTD., Tianjin (CN)

(72) Inventors: KUANG-HUI MA, New Taipei (TW); SHANG-YI LIN, New Taipei (TW); LI-MING CHEN, Neihu (TW); KAI-HSUN HSUEH, New Taipei (TW)

(21) Appl. No.: 17/329,885

(22) Filed: May 25, 2021

(30) Foreign Application Priority Data
Jun. 9, 2020 (CN) 202010519816.0

(51) Int. Cl. B29C 45/78; B29C 45/84; B29C 45/77; B29C 45/80

(52) U.S. Cl. CPC B29C 45/78; B29C 45/84; B29C 45/77; B29C 45/80; B29C 2945/76006; B29C 2945/7604; B29C 2945/76381; B29C 2945/7609; B29C 2945/76254; B29C 2945/76287; B29C 2945/7621; B29C 2945/76397; B29C 2945/76464; B29C 2945/76086

(57) ABSTRACT

A system and a method for monitoring states of an injection molding machine includes a data collector, a controller, and an alarm apparatus. The data collector communicates with a molding equipment, a mold, and a mold temperature controller. Data of the molding equipment, data of the mold, and data of the mold temperature controller is constantly collected in real time by the data collector. The controller determines whether the data comprises a value exceeding a predetermined value range. The alarm is activated if the data is determined to comprises a value exceeding the predetermined value ranges.

### FIELD

The subject matter herein generally relates injection molding, especially to a method and a system for monitoring states of an injection molding machine.

### BACKGROUND

Injection molding is widely used to produce plastic products. An injection molding process of the plastic products includes four phases including a preparation phase (a phase of heating the mold and drying the materials), an injection and pressure holding phase (including an injection phase and a pressure holding phase), a cooling phase (including a glue melting phase and a post-cooling phase), and a mold-opening and ejection phase. In each phase of the injection molding process, if the molding parameters do not meet the standards, the product quality will be reduced. However, the molding parameters are monitored manually.

### BRIEF DESCRIPTION OF THE DRAWINGS

Implementations of the present technology will now be described, by way of embodiment, with reference to the attached figures.

FIG. 1 is a block diagram of a system for monitoring states of an injection molding machine, in accordance with an embodiment of the present disclosure.

FIG. 2 is a flowchart of a method for monitoring states of an injection molding machine, in accordance with an embodiment of the present disclosure.

FIG. 3 is a flowchart of a method for determining a value range in relation to an injection molding machine, in accordance with an embodiment of the present disclosure.

FIG. 4 is a block diagram of a system for monitoring states of an injection molding machine, in accordance with other embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like.

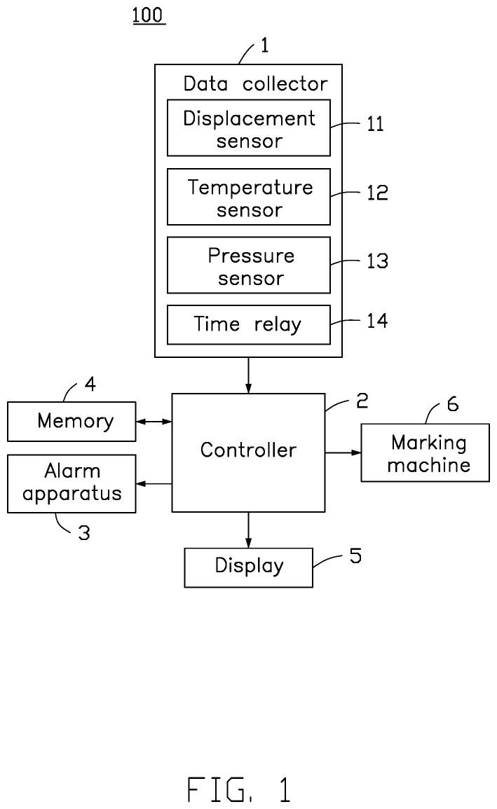

FIG. 1 illustrates a system 100 adapted for monitoring states of an injection molding machine in a first embodiment. The system 100 is applied to the injection molding machine which includes a molding equipment, a mold, and a mold temperature controller. The system 100 includes a data collector 1, a controller 2, and an alarm apparatus 3. The data collector 1 and the alarm apparatus 3 each communicates with the controller 2.

The data collector 1 is disposed at any position where data as to the molding equipment, data as to the mold, and data as to the mold temperature controller is needed. The data collector 1 communicates with the molding equipment, the mold, and the mold temperature controller, and is configured to collect data of the molding equipment, data of the mold, and data of the mold temperature controller in the molding process. Under the condition that the equipment can afford, the data collector 1 can collect the data of the mold and the data of the mold temperature controller in a high frequency, and the collection frequency can be in a range of 20 Hz to 50 Hz. In one embodiment, the collection frequency is 20 Hz, 30 Hz, 40 Hz, or 50 Hz.

In the preparation phase of the molding process of a plastic product, it is to be monitored whether the plastic particles entering a barrel of the molding equipment have been dried and an internal temperature of the mold. In the injection and pressure holding phase of the molding process of a plastic product, a displacement of a screw of the molding equipment, temperature changes and pressure changes within the mold, and a molding time period must be monitored. In the cooling phase of the molding process of a plastic product, cooling condition of the mold must be monitored. In the mold-opening and ejection phase of the molding process of a plastic product, a temperature of the surface of the obtained product must be monitored. Thus, different collectors must be set at different data collection spots. According to the different types of data which need to be collected, the data collector 1 includes but is not limited to a displacement sensor 11, a temperature sensor 12, a pressure sensor 13, and a time relay 14.

The data to be collected in the molding process includes but is not limited to the data of the molding equipment, the data of the mold, and the data of the mold temperature controller.

As shown in Table 1, according to the different molding parameters of the molding process that need to be collected in the above four phases, different data collectors are set for three kinds of molding equipment.

TABLE 1

| Installation | | | |
|---|---|---|---|
| location of | | | |
| the data | | Types of data | |
| collector | Parameters | collectors | Interpretation of parameters |
| In the | Start point of | Displacement | The position of the screw at the beginning |
| molding | injection | sensor | of the injection and pressure holding |
| equipment | | | phase |
| | End point of | Displacement | The position of the screw at the end of the |
| | injection | sensor | injection and pressure holding phase |
| | Travel | Displacement | The distance between the start and end |
| | distance of | sensor | position of the screw in the injection and |
| | screw | | pressure holding phase |
| | Switching | Displacement | The position of the screw when the |
| | position | sensor | injection phase is switched to the pressure |
| | | | holding phase |
| | Switching | Time relay | The time period from the beginning of the |
| | time period | | preparation phase to the end of the |
| | | | injection phase for each product |
| | Switching | Pressure | The pressure applied to the plastic by the |
| | pressure | sensor | screw when the injection phase is |
| | | | switched to the pressure holding phase |
| | Glue melting | Displacement | The position of the screw when the |
| | terminus | sensor | material tube begins to enter into the glue |
| | | | melting phase |
| | Glue melting | Time relay | The time period for the material tube to |
| | time period | | perform the glue melting process for the |
| | | | next unfinished product when the finished |
| | | | product starts to cool |
| | Post-cooling | Time relay | Time period for post-cooling |
| | time period | | |
| | Temperature | Temperature | The average temperature of nozzle of |
| | of injection | sensor | molding equipment corresponding to each |
| | nozzle | | product during the molding process |
| In the mold | Pressure of | Pressure | The pressure applied to the plastic |
| | plastic | sensor | materials entering the mold during the |
| | materials | | injection phase |
| | Temperature | Temperature | The temperature of the plastic materials |
| | of plastic | sensor | entering the mold during the injection |
| | materials | | phase |
| | Temperature | Temperature | The temperature of the male mold during |
| | of male mold | sensor | the molding process |
| | Temperature | Temperature | The temperature of the female mold |
| | of female | sensor | during the molding process |
| | mold | | |
| At the outlet | Temperature | Temperature | The temperature of the hot water supplied |
| of the mold | of hot water | sensor | to the mold during the preparation phase |
| temperature | | | and the injection and pressure holding |
| controller | | | phase |
| | Temperature | Temperature | The temperature of the cold water |
| | of cold water | sensor | supplied to the mold during the cooling |
| | | | phase |

As shown in Table 1, different data collectors 1 are set at different positions to collect the data. Table 1 only shows some readings to be collected in the molding process, and the number and type of data collectors 1 can be increased or decreased according to needs.

For the molding equipment, each molding product generally has only one set of data in a production cycle. For the mold and the mold temperature controller, according to the arrangement of the collection frequency of the data collector 1, each molding product has multiple sets of data in the production cycle. In other words, each molding product will be associated with a series of data for each specific data to be detected. For example, for the temperature of plastic materials in the mold, each molding product will have a series of data according to the arrangement of the data collection frequency.

The controller 2 is configured to receive the data collected by the data collector 1 and to determine whether the data comprises a value exceeding a predetermined value range.

The alarm apparatus 3 is configured for issuing an alarm if the data is determined to comprise a value exceeding the predetermined value range. If the data which is collected in real time comprises a value exceeding the predetermined value range, the alarm apparatus 3 will give an alarm.

Different alarm levels can be set through the controller 2, and the characteristics of an alarm can be distinguished by a size of a deviation from a predetermined value range. In one embodiment, the alarm apparatus 3 is a buzzer. When the deviation from a predetermined value range is small, the sound of the buzzer is relatively small. With a larger deviation, the sound of the buzzer is increased. In other embodiment, the alarm apparatus 3 is a lamp which can emit light of different colors. According to the size of deviation, the lamp can flash in different colors.

If the production parameters of the mold temperature controller, the mold, and the molding equipment are abnormal, it is usually not accidental, and it is generally caused by the aging of the machine. According to different alarm levels, operators can know in advance whether the molding equipment is aging, and carry out maintenance in time, so as to avoid the decline of product yield caused by the aging of molding equipment, and the production loss is reduced.

In one embodiment, a means of eliminating errors is also designed for accidental fluctuation of the data. For example, the alarm will not be given until the number of times of deviation from the predetermined value range exceeds a predetermined number, such as two or three. If the deviation is small, the predetermined number of deviations before an alarm is given may be three or four times. Thus, a false alarm caused by the fluctuation of errors is avoided, the production efficiency is improved. It is to be understood, the above limitation on the number of times is limited to explaining the means of eliminating errors.

The system 100 further includes a memory 4, which is configured to store the data and the predetermined value range, and after the data is stored, it can facilitate the later access and comparisons done by the controller 2.

The system 100 further includes a display 5, which is configured to display the data, the predetermined value range, and the alarm data in real time, so as to facilitate viewing by the operator.

The system 100 further includes a marking machine 6, which is configured to print a production number or mark on the molding product for subsequent identification.

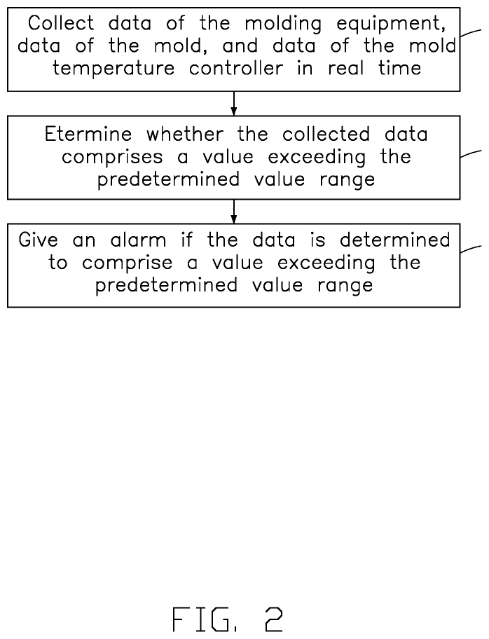

Referring to FIG. 2, a flowchart of a method for monitoring the states of an injection molding machine is presented in accordance with an example embodiment which is thus illustrated. The method described below can be carried out using the configurations illustrated in FIG. 1, for example, and various elements of these figures are referenced in explaining example method. The exemplary method can begin at block S1.

At block S1, collect data of the molding equipment, data of the mold, and data of the mold temperature controller in real time.

First, the data collector 1 is installed at the corresponding positions of the molding equipment, the mold, and mold temperature controller to collect the production data, as shown in Table 1 (Table 1 only lists the position and collected data of a part of the data collector 1). The data collected by the data collector 1 at the corresponding position represents the production data of the molding equipment, the mold, and the mold temperature controller during the production process. And then, under the same production conditions, the data of each molding product collected by the data collector 1 at each time point of each phase of the molding process is recorded. Under the condition that the equipment can afford, the data collector 1 can collect the data of the mold and the data of the mold temperature controller in a high frequency, and the collection frequency can be in a range of 20 Hz to 50 Hz. For example, the collection frequency is 20 Hz, 30 Hz, 40 Hz, or 50 Hz.

At block S2, determine whether the collected data comprises a value exceeding the predetermined value range.

When the collected data comprises a value within the predetermined value range, it is determined as a good product. When the collected data indicates a value which is not within the predetermined value range, it is determined as a defective product. According to the data corresponding to the defective product and the specific parameters of the production process, whether the molding equipment is aging is detected, so as to warn in advance to avoid the defective product caused by the aging or failure of the equipment.

At block S3, give an alarm if the data is determined to comprise a value exceeding the predetermined value range.

If the real-time data comprises a value exceeding the predetermined value range, different levels of alarms are given according to the deviation. For example, the average temperature of hot water corresponding to the good product in the injection stage is in a range of 60° C. to 70° C. If the temperature of hot water corresponding to the molding product is not in this range, different levels of alarm will be given according to the deviation, and the molding equipment needs to be repaired in time to avoid bad batch caused by the equipment problems.

In the classified alarm for different degree of deviation, the specific level of alarm can be set according to needs. In one embodiment, the alarm apparatus 3 is a buzzer. When the deviation from the predetermined value range is small, the sound of the buzzer is relatively small. With a larger deviation, the sound of the buzzer is increased. In other embodiment, the alarm apparatus 3 is an alarm lamp which can emit light of different colors. According to the size of deviation, the alarm lamp can flash in different colors. In one embodiment, a means of eliminating errors is also designed for accidental fluctuation of the data. For example, the alarm will not be given until the number of times of the deviation from the predetermined value range exceeds a predetermined number, such as two or three times. If the deviation is small, the predetermined number of deviations before an alarm is given may be three or four times. Thus, a false alarm caused by the fluctuation of errors is avoided, the production efficiency is improved.

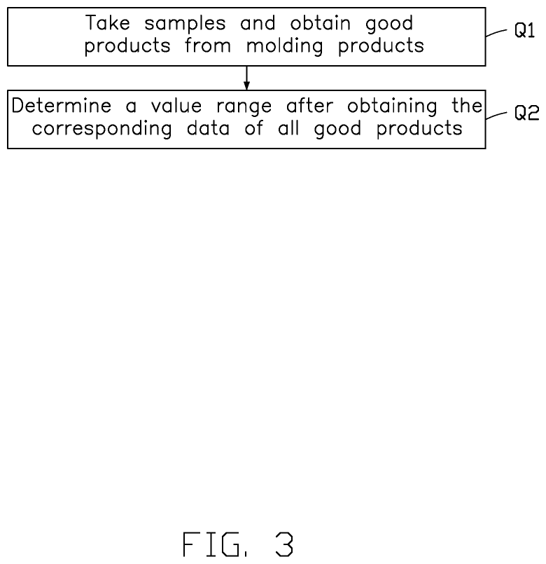

Referring to FIG. 3, a flowchart of a method for determining a value range is presented in accordance with an example embodiment which is thus illustrated. The exemplary method can begin at block Q1.

At block Q1, take samples and obtain good products from molding products. In the production process, the molding products are sampled and inspected, and the sampled molding products are compared with the standard good product (the specific comparison items include product appearance, size, etc.) to determine the good products. The numbers of the good products obtained by sampling inspection are matched with the corresponding data, that is, each good product will correspond to a series of data in the whole molding process.

In one embodiment, the sampling inspection of the molding products is carried out manually. Several products can be sampled continuously or irregularly. For example, more than twenty products can be sampled at the beginning, or one product can be sampled every ten products. Determine the quality of the sampled products according to the standard samples and observe whether the appearance of the sampled products is defective or whether the dimensions are out of specification, so as to obtain the good products, and record the product number of each good product.

At block Q2, determine a value range after obtaining the corresponding data of all good products. Since each molding product has a series of data in a production cycle and the number of good products is more than one, the controller 2 needs to calculate according to the series of data to obtain the value range corresponding to each parameter. For the data of the mold and the mold temperature controller, since the data collector 1 collect data with high frequency, there are multiple sets of data for each molding product in a production cycle, that is, there are a series of data for each specific data to be detected for each molding product. The average value, the median value, the maximum value, the minimum value, and the sum of the value, of the data corresponding to each molding product in all stages of the molding process can be calculated. For the data of the molding equipment, there is only one data for each molding product, but for the process data of all good products, it is necessary to calculate the corresponding range and sort out the obtained data to determine the corresponding value range.

The value range is updated in real time. The value range is a dynamic range, which can be adjusted continuously according to the advance of production. After the value range is determined and the data collector 1 collects the data of the molding product, the data of good products obtained through sampling inspection will be transmitted to the controller 2, and the controller 2 will automatically update the data.

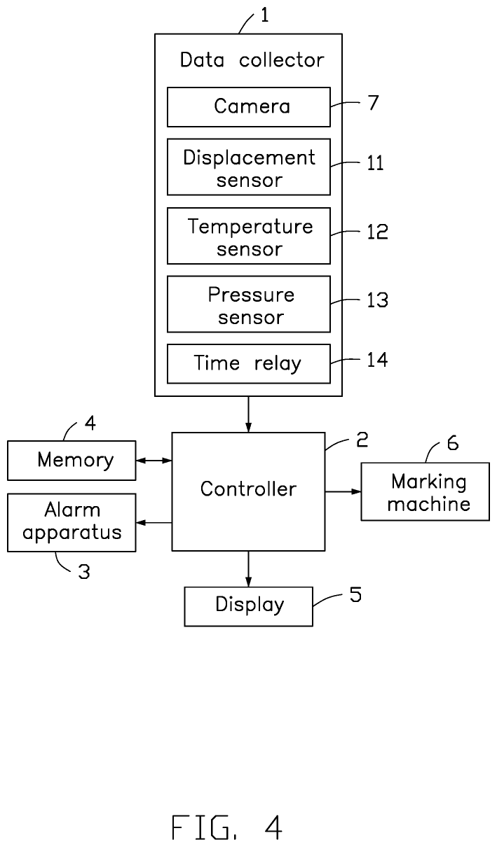

FIG. 4 illustrates a system for monitoring states of an injection molding machine in a second embodiment. The difference between the second embodiment and the first embodiment is that the data collector 8 also includes a camera 7. The camera 7 is used for collecting the image of the molding product. The controller 2 is further configured to receive the image transmitted by the camera 7, compare the image with a preset image of good products, and determine whether the molding product meets a preset standard according to the transmitted image. If the molding product is determined to meet a preset standard, the molding product is good. Using the camera 7 and the controller 2 to cooperate with each other, it can realize online automatic sampling, extract the quality parameters of good products, and avoid manual sampling. The obtained good product corresponds to the corresponding data to determine the value range.

Through the system, early warning can be given for the maintenance of the mold temperature controller or the molding equipment, so as to avoid the decline of yield caused by the aging of the machine. Compared with the way of manual monitoring the state of an injection molding machine, the number of defective products is decreased.

While the present disclosure has been described with reference to particular embodiments, the description is illustrative of the disclosure and is not to be construed as limiting the disclosure. Therefore, those of ordinary skill in the art can make various modifications to the embodiments without departing from the scope of the disclosure as defined by the appended claims.

What is claimed is:

1. A system adapted for monitoring sates of an injection molding machine, the injection molding machine comprising a molding equipment, a mold, and a mold temperature controller, the system comprising:
a data collector communicating with the molding equipment, the mold, and the mold temperature controller, and being configured to collect data of the molding equipment, data of the mold, and date of the mold temperature controller in real time;
a controller configured to receive the data collected by the data collector and to determine whether the data comprises a value exceeding a predetermined value range; and
an alarm apparatus configured for issuing an alarm if the data is determined to comprise a value exceeding the predetermined value range.

2. The system of claim 1, wherein the data of the molding equipment comprising a position of a start point of injection, a position of an end point of injection, a switching position, a switching time period, a switching pressure, a glue melting terminus, a glue melting time period, a post-cooling time, and a temperature of an injection nozzle.

3. The system of claim 2, wherein the data of the mold comprises a pressure of plastic materials, a temperature of plastic materials, a temperature of a male mold, and a temperature of a female mold.

4. The system of claim 3, wherein the data of the mold temperature controller comprises a temperature of hot water and a temperature of cold water.

5. The system of claim 4, wherein the data of the mold and the data of the mold temperature controller are collected in a frequency ranging of 20 Hz to 50 Hz.

6. The system of claim 1, wherein the data collector comprises a camera, the camera communicates with the controller and is configured to collect an image of a molding product in real time, the controller is further configured to receive the image transmitted by the camera and to determine whether the molding product meets a preset standard according to the transmitted image.

7. The system of claim 1, further comprising:
a memory communicating with the controller and configured to store the data and the predetermined value range;
a display communicating with the controller and configured to display the data, the predetermined value range, and the alarm data in real time; and
a marking machine configured to print a production number on a molding product.

8. A method for monitoring states of an injection molding machine, the injection molding machine comprising a molding equipment, a mold, and a mold temperature controller, the method comprising:
collecting data of the molding equipment, data of the mold, and data of the mold temperature controller in real time;
determining whether the data comprises a value exceeding a predetermined value range; and
giving an alarm if the data is determined to comprise a value exceeding the predetermined value range.

9. The method of claim 8, wherein the alarm is given according to a size of a deviation from the predetermined value range.

10. The method of claim 8, wherein a value range is determined by a method comprising:
obtaining data of the molding equipment, data of the mold, and data of the mold temperature controller corresponding to a good product in real time;
determining a value range according to the corresponding data of all good products.
